(19) United States
(12) Patent Application Publication
(10) Pub. No.: US 2013/0083259 A1
(43) Pub. Date: Apr. 4, 2013

(54) OPTICAL ENHANCEMENT FOR DISPLAY TOUCHSCREEN SYSTEMS

(71) Applicant: Honeywell International Inc., Morristown, NJ (US)

(72) Inventors: Dennis Davey, Phoenix, AZ (US); Brent D. Larson, Cave Creek, AZ (US); Steven Haim, Glendale, AZ (US)

(73) Assignee: HONEYWELL INTERNATIONAL INC., Morristown, NJ (US)

(21) Appl. No.: 13/630,804

(22) Filed: Sep. 28, 2012

Related U.S. Application Data
(60) Provisional application No. 61/541,263, filed on Sep. 30, 2011.

(51) Int. Cl. G02F 1/1335

(52) U.S. Cl. 349/12

(57) ABSTRACT

Methods and apparatus are provided for the mitigation or elimination of optical artifacts from an LCD touch screen device resulting from the coupling of an LCD and a touchscreen. The apparatus comprises a high fill factor diffuser layer interposed at a specified distance between a LCD panel and a touch screen, wherein a blurring across a distance x of the LCD panel is a function of the distance between the diffuser layer and the LCD panel and the scattering profile of the diffuser layer.

### PRIORITY APPLICATIONS

The instant application is a utility patent application the claims priority pursuant to 37 C.F.R. §1.120 to provisional application 61/541,263 filed on Sep. 30, 2011, which is incorporated herein by reference in its entirety.

### TECHNICAL FIELD

The present invention generally relates to touchscreen systems, and more particularly relates to methods and devices for eliminating or reducing optical artifacts such as Moire patterns.

### BACKGROUND

The prevalence of display systems and devices that include touch screens is increasing. However, in certain cases optical artifacts such as Moire patterns occur. These effects can happen, for example, when one manufacturer's touchscreen is coupled to another vendor's LCD display. It has been determined that both devices incorporated patterned substructure within individual layers. Despite being highly transparent, the usual touch screen layers exhibited sufficient transmittance modulation of the pixelated LCD display output to result in Moiré-style interference artifacts (e.g., spatial “beat frequencies”) which were readily visible.

When appropriate time and resources are available, it should be possible to custom design suitably compatible displays using touch screens such that artifacts are minimized or eliminated. However, in other applications and in varied environments, the opportunity for developing optimal touchscreen systems is cost prohibitive.

Accordingly, it is desirable to devise a system or means to attenuate or eliminate optical artifacts independently of the underlying design of the touchscreen. In other words, it is desirable to minimize optical artifacts without the redesign or modification of the touchscreen device of concern.

### BRIEF DESCRIPTION OF THE DRAWINGS

The present invention will hereinafter be described in conjunction with the following drawing figures, wherein like numerals denote like elements, and

FIG. 1 is a simplified side view of a simple layer stack for a touchscreen display device according to embodiments;

FIG. 2 is a diagram showing the relationship between the scattering angle profile of the diffuser and the resulting optical effect on the pixelated LCD panel;

FIG. 3 is a simplified diagram illustrating the raw pixel illumination (s) compared to the blurred image (w) and relative to the pixel pitch.

FIG. 4 is a diagram depicting the raw pixel illumination and blurred profiles across all three sub-pixels (R-B-G) in a color pixel;

FIG. 5 is an illustration of experimental data contrasting the effect of two ordinary anti-glare structures and the high fill factor diffuser disclosed herein;

FIG. 6 is a diagram depicting two exemplary scattering angle profiles for an anisotropic diffuser according to an embodiment of the present invention; and

FIG. 7 illustrates a simplified pixel geometry with which an anisotropic diffuser might be used.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

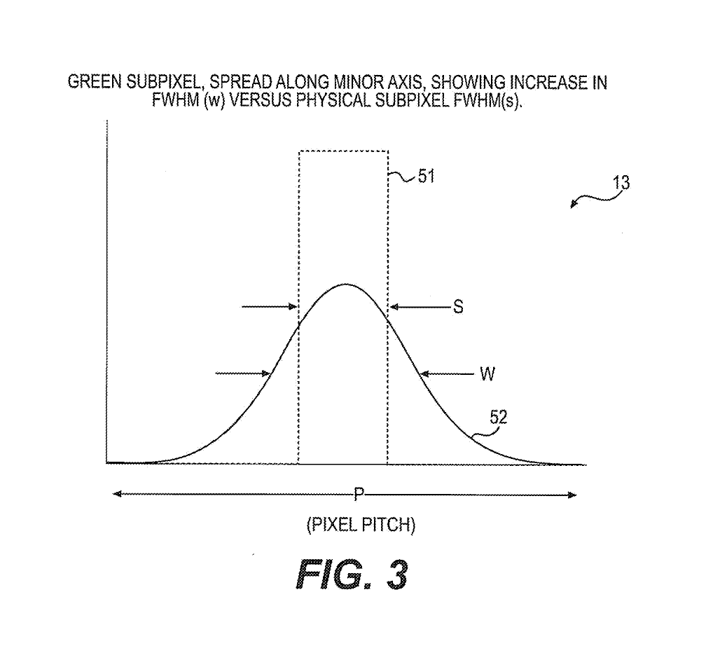

The approach developed herein to reduce the optical artifacts to an acceptable threshold level included the insertion of a specially selected light scattering diffusion film having a suitably broadened Full Width Half Maximum profile (w) relative to the physical dimensions of the pixel of the LCD stack between the LCD and the touchscreen (e.g., pixel pitch, pixel dimensions, substrate thickness, thickness of air gap, angle of incidence, refractive index, etc.) (See, FIG. 3).

The particular diffusion film utilized is a surface relief diffuser as opposed to a volume diffuser. The surface structure of the surface relief diffuser selected may either have diffusing particles applied to the surface of the diffuser or the diffuser may be cast or embossed with a scattering structure or pattern. The applied particles or scattering structure is very fine (i.e., high resolution) where the typical feature size is preferably smaller than, and more preferably at least 3 times smaller than the size of the underlying LCD pixels and/or subpixels. A suitable volume diffuser with similar operational qualities to the comparable surface diffuser may also be used. Here, the term volume diffuser implies that at least a portion of the light scattering by the diffuser is due to refractive index variations within the bulk of the diffuser, rather than solely due to one or more surfaces of the diffuser. The criteria for selection of an effective diffusion film involve the relationships between several parameters, described in more detail below.

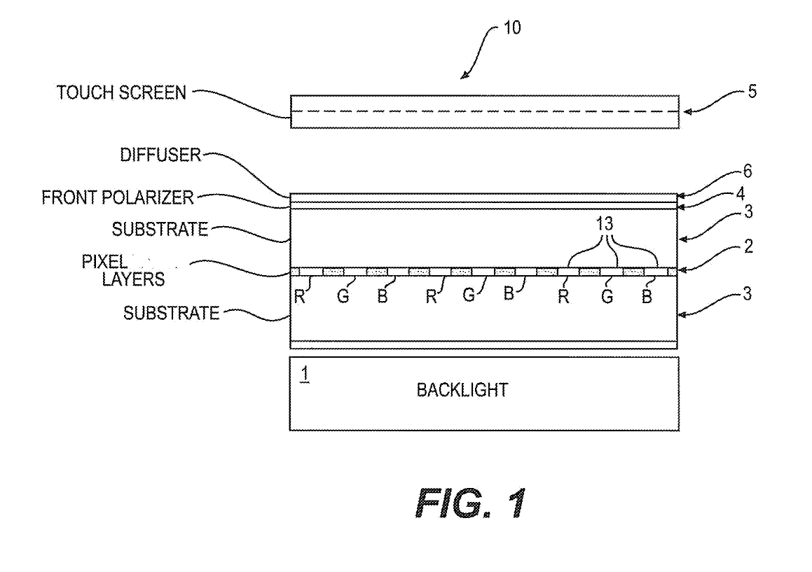

FIG. 1 is a simple side view of a simple LCD layer stack 10 for an exemplary LCD touchscreen device according to embodiments disclosed herein. The layer stack includes a backlight 1 and a touchscreen 5. Backlight 1 may be any backlight known in the art or that may be devised in the future. The LCD layer stack 10 also includes internal multi-pixel/subpixel LCD panel layer(s) 2 that are sandwiched between substrates 3. The substrate(s) 3 are typically glass, with an approximate refractive index of n=1.5. The stack may also include a front polarizer 4 as is commonly known in the art for conditioning the light passed by the LCD internal layer 2 from the backlight 1.

The LCD layer stack 10 as disclosed herein also includes a diffuser or diffusing layer 6 between the LCD panel 2 and the touchscreen 5. The diffuser 6 may be either a surface diffuser or a volume diffuser. In either case the diffuser 6 has a very high fill factor of scattering features, meaning that the distance between scattering features is small, preferably smaller than and more preferably many times (e.g., at least 3 times) smaller than the size of the underlying LCD pixels and/or subpixels 13. The high fill factor substantially minimizes the passage of undeflected image rays. In contrast, many conventional anti-glare surface treatments still allow a noticeable portion of light to be transmitted without significant deflection, and would therefore not satisfy the requirements of the current subject matter. Hence, typical anti-glare films are not good candidates for this application, per se.

A proper construction of an LCD layer stack 10 to deal with optical artifacts calls for a suitable separation distance (d) between the diffuser 6 and one or both of the touchscreen 5 and the LCD panel 2 internal pixelated or otherwise finely patterned layers. This allows, for example, the light incident on the rear of the diffuser 6 to be defocused or blurred thereby rendering a slightly blurred representation of the display pixels of the LCD panel 2. FIG. 1 shows diffuser 6 as being laminated to the front of the LCD front polarizer 4, although an air gap or other layers, such as additional substrates, coatings or other refractive materials, could also be added between the two elements.

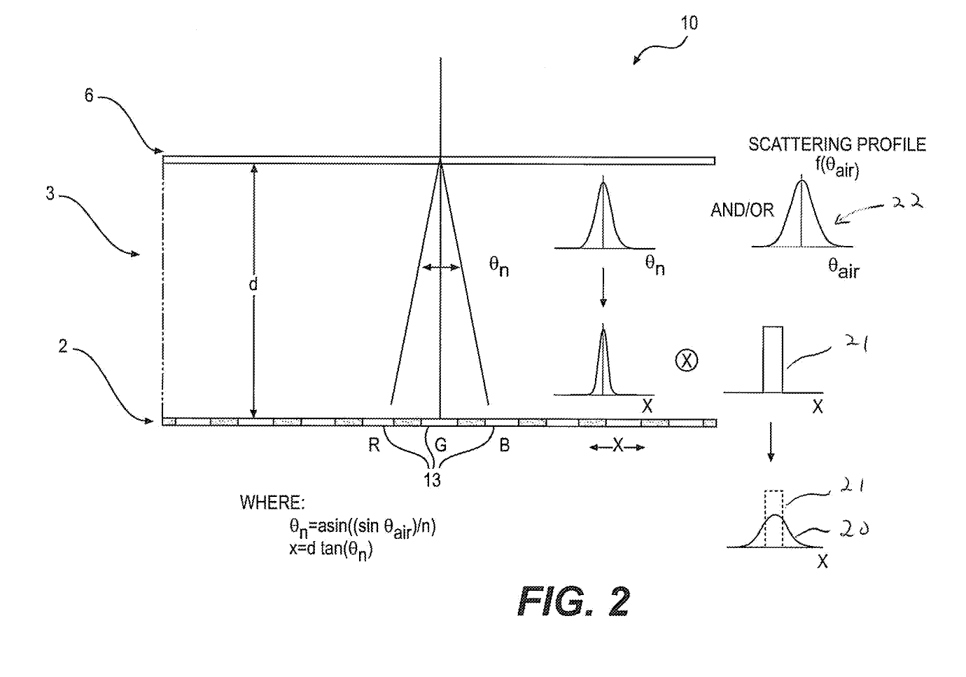

The proper construction of the LCD layer stack 10 also calls for small scattering angle or deflection angle θₙ meaning a relatively high gain diffusion film but where the gain is a lower gain than the gain of a conventional antiglare film. The scattering angle θₙ is small (i.e., on the order of a few degrees) but large enough to suppress or reduce both the number and amplitudes of the spatial harmonics associated with the effective pixel profile (i.e., band-limit) when reproducing the input image and to suppress spatial frequency harmonics, but still small enough to avoid substantial degradation of the desired image content. Thus, the scattering angle θₙ is still small enough to avoid substantial degradation of the desired image content. Further, definition of the scattering angle and the desired range of scattering angles is discussed in more detail below, especially as it relates to other parameters such as the separation between the layers (d) (see FIG. 2, where x is comparable to a sub-pixel dimension).

FIG. 2 is a simplified illustration of a partial LCD layer stack 10 geometry including the diffuser 6, the internal LCD panel layers 2 and a substrate 3 with a separation distance d (inclusive of a polarizer or other layers if needed, though not shown). The light scattering profile of the device is the relative light scatter as a function f(θₐᵢᵣ) of the scattering angle in air (θₐᵢᵣ). The scattering angle in the substrate 3 is θₙ, which is adjusted from θₐᵢᵣ based on the refractive index n, and varies for example from −90 to +90 degrees. A more precise range, assuming a refractive index of 1.5, would be −41.8 to +41.8 degrees. The depiction of θₙ in FIG. 2 is intended to show the general nature of the scattering angle. The relative sizes of θₙ, thickness d and the subpixel features shown along the x direction in FIG. 2 are not meant to be limiting. Extending that scattering angle from the diffuser 6 to the internal LCD layers 2, including subpixels as shown, results in a related effective scattering function, which is a function of lateral displacement of the pixels x. Formulas relating the various parameters discussed above are:

θₙ=a sin ((sin θₐᵢᵣ)/n)

x=d tan(θₙ)

The exemplary subpixel luminance profile 21 (e.g., luminance versus x) is thereby convolved with the effective scattering profile f(θₐᵢᵣ) 22 to determine the observed, blurred subpixel profile 20, shown in the lower right of FIG. 2 superimposed on the raw pixel profile 21. If, in a related embodiment, a portion of the separation distance (d) between diffuser 6 and LCD Panel pixel layer contains air, the contribution by that portion would be calculated using n=1. Note that while FIG. 2 describes the angular spread from a particular viewing line-of-sight onto adjacent subpixels within LCD panel 2, a comparable analysis could also be performed based on light passing through LCD panel 2 from below (in FIG. 2) and being diffused and mixed by diffuser 6.

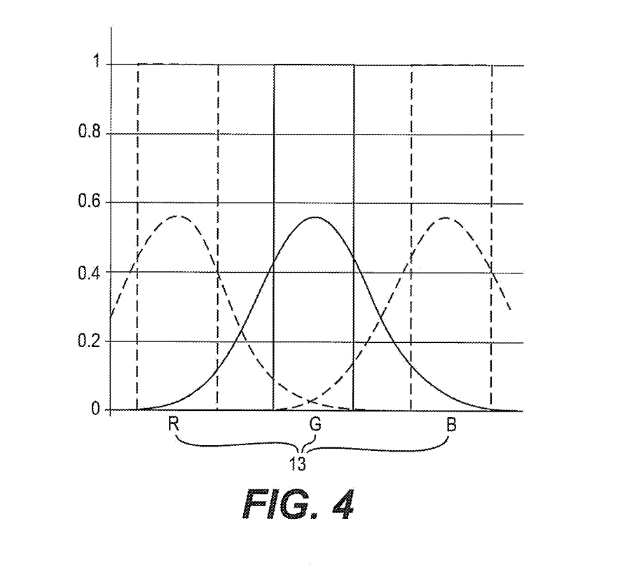

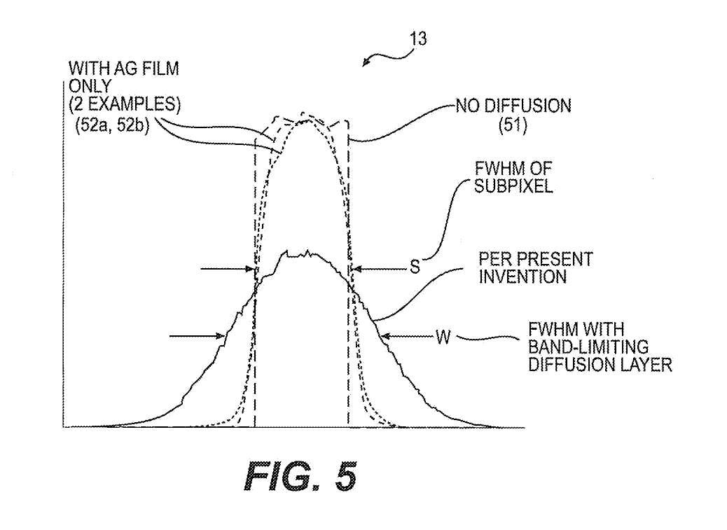

This blurred subpixel profile is shown more clearly in FIG. 3. Also depicted are the Full Width at Half Maximum (FWHM) dimensions of the subpixel optical profile (51) without the blurring (s) and with the blurring (w) 52 by diffuser 6 (See, FIG. 5). The original luminance cross-sectional profile through the subpixel of a particular color (e.g., green) shows, as an example, a rectangular profile having FWHM of s. The blurred profile has less steep edges and a FWHM of w, where w>s. In a color display, each of the color subpixels will in general be broadened similarly, as depicted in the normalized chart of FIG. 4. In each of these examples, the area under the curve has been normalized to the same value (e.g., a value of 1), representative of a diffusing or broadening of a line along the orthogonal to that line. The exact shapes and amplitudes may vary with details such as pixel shape, diffuser scattering asymmetry (if any), wavelength dependence of the scattering profile and so forth without departing from the scope of the subject matter disclosed herein. Similar examples could be shown with respect to alternate directions relative to the two dimensional pixel array, and the nature of the subpixel widths shown, if any, would depend upon the particular subpixel pattern for the exemplary display. As another example, many monochrome displays have one subpixel per pixel area. Other displays may have more than one.

The subject matter disclosed herein requires that the characteristics listed above work together to optically blend or suppress individual spatial harmonic Fourier peaks or frequency components of the display so as to preclude or significantly reduce interference with the spatial harmonic peaks of the touch screen. The blurring and broadening of the subpixel profiles (See, FIGS. 3 and 4) are analogous to a band-limiting, therefore greatly limiting the opportunity for Moire interference with spatial harmonic peaks of the touch screen.

It should be stressed that the subject matter being disclosed herein is not merely simple combinations of an anti-glare display surface and a touchscreen. To illustrate this distinction, FIG. 5 shows a representative rectangular profile (no diffusion) 51 along with two examples of effective profiles (52a and 52b) as blurred slightly by conventional anti-glare structures. The FWHM of the anti-glare examples are substantially identical to the FWHMs of the original profile.

In contrast, a diffuser as described herein broadened the original profile to a FWHM of w, where w>s. The separations and measurement geometries for each of these representative curves were the same. The ratio of w/s is preferably greater than 1.2, and more preferably greater than 1.5. In the example of FIG. 5, the ratio of w/s is approximately 1.65. At the same time, it is desirable that (w) not be large enough to significantly degrade the sharpness of the displayed image content. For example, it is preferable that w be less than approximately two to three times the pixel pitch (p) (i.e., w/p<3 and more preferably less than 2), where the pixel pitch is typically associated with the size of a minimum addressable image element capable of spanning the addressable color gamut of the display.

As shown in FIGS. 1 and 2, the path for backlight illuminated rays between the internal layers 2 and the diffusing layer 6 is a direct path rather than a re-imaging path, meaning that there are no intervening re-imaging element(s) such as a projection lens, an array of microlenses, a fiber optic faceplate substrate, or similar optical element(s) present. This direct path limits the maximum separation between LCD Panel pixel layer 2 and diffuser 6 to avoid significantly degrading the desired image content.

While Moiré-style interference artifacts can in general appear quite complex, it is not uncommon that any visible Moiré modulation can be more significant along a first axis than along a second axis at some non-zero angle (e.g., ninety degrees) with respect to the first axis. For example, for a subpixel arrangement where FIG. 4 represents a horizontal scan through the pixel, it may be sufficient to primarily diffuse or band-limit the subpixels along that horizontal axis as shown. In other words, diffuser 6 may in some cases provide anisotropic diffusing characteristics or profiles. This allows the diffusion to be applied along the orientation for which it is most effective for suppressing the Moiré-style interference artifacts, while minimizing any degradation of image detail (e.g., maintaining a ratio of w/s closer to 1.0) along a second direction. The optimal orientation of such an anisotropic diffuser will depend upon the substructure and orientation of both the LCD panel pixel layer 2 and the touch screen 5.

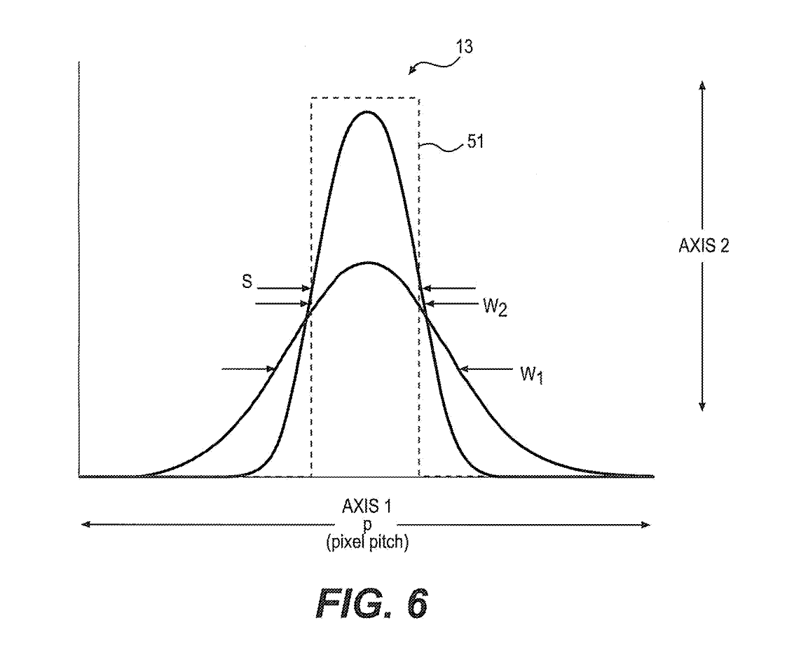

Exemplary diffusion profiles for such an anisotropic diffuser are shown shown in FIG. 6. Here the blurring or broadening that would occur with a particular feature width s is shown for two orthogonal axes of the anisotropic diffuser using geometries corresponding to that of FIG. 2. Along a first axis (axis 1), the feature with original width (FWHM) s would be broadened to a FWHM of w₁, whereas along the second axis (axis 2), a comparable feature of original width (FWHM) s would be broadened to a FWHM of w₂, with w₂<w₁.

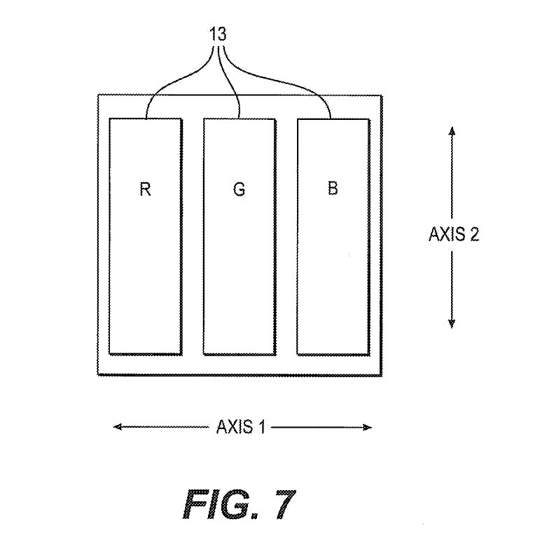

FIG. 7 shows a non-limiting example of how such an anisotropic diffusion profile might be utilized with a pixel array (only one pixel in the pixel array is shown). In the embodiment of FIG. 7, the first axis is oriented in a direction which crosses all color subpixels, such as the R, G and B subpixels shown. Axis 2 is orthogonal to Axis 1, and therefore is not used to mix the subpixel colors for the simplified subpixel pattern shown, sometimes called a “stripe” subpixel arrangement. As such, it may be unnecessary to significantly blur the pixels along axis 2, in which case image sharpness along that axis may be retained by limiting the blurring associated with w₂. In the example in FIG. 6, there is still slight spreading of the FWHM w₂ relative to s, but in other embodiments w₂ and s could be substantially identical.

Numerous variations on the described configurations are possible. The diffusion layer 6 can be free-standing or can be laminated to either the substrate 3 or the touch screen 5, provided the surface relief diffusing structure 6 is exposed to a suitable low index medium such as air (index (n)=1.0). Alternately, a suitable volume diffuser 6 can be used, which would then allow lamination on both sides if desired. Anti-reflection coatings and other measures such as polarization techniques can be implemented to minimize specular or diffuse reflections associated with the inclusion of the diffusion layer. Other pixelated display technologies, such as Active Matrix Organic Light Emitting Diode (AMOLED) displays, can be substituted for the LCD panel and backlight combination.

A factor in the success of the above described configuration is the proper characteristic light scattering due to the diffusion film. Image quality is maximized by incorporating, as described above, very fine scattering granularity with very high fill factor, while at the same time avoiding excessive scattering angles (through directional or high-gain diffusion) and avoiding separations (d), which are too large or too small, as discussed above in terms of in terms w/p and w/s. In this way the underlying display image can be band-limited to remove spatial harmonics without significantly degrading the desired image content.

In some embodiments, the diffusion layer is sufficiently dense and disposed far enough from the modulated (active) layer of the display such that it substantially hides the pixel substructure when viewed visually such that the pixel substructure is difficult or impossible to detect by eye while only minimally degrading the intended displayed image if at all. In other equivalent embodiments, the scattering and location of the diffusion layer are sufficient to substantially mask substructure (e.g. non-zero frequency components or harmonics) in the Fourier spectrum or coherent diffraction pattern that specifically contribute to Moire patterns when combined with a patterned touch screen. Both of these scenarios served to reduce or eliminate Moire patterns due to the optical stacking of the display and touch screen.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A touchscreen stack comprising:
a touchscreen;
a pixelated display layer, wherein each pixel has a specific pixel pitch; and
a diffuser with a scattering angle, the diffuser disposed between the touchscreen and the pixelated display layer at a separation distance from the pixelated display layer, wherein the separation distance is equal to a function of lateral displacement across the pixelated display layer divided by a tangent of a scattering angle.

2. The touchscreen stack of claim 1, wherein the pixelated display layer comprises an array of pixels, each pixel of the pixelated display layer comprises one or more subpixels, at least one of the one or more subpixels having a first linear Full Width Half Maximum (FWHM) dimension profile along a first axis.

3. The touchscreen stack of claim 2, wherein the scattering angle of the diffuser blurs and broadens the first linear FWHM dimension profile to produce a wider second linear FWHM dimension profile along said first axis.

4. The touchscreen stack of claim 3, wherein a ratio of the second linear FWHM dimension profile to the first linear FWHM dimension profile is greater than 1.2.

5. The touchscreen stack of claim 3, wherein a ratio of the second linear FWHM dimension profile to the first linear FWHM dimension profile is greater than 1.5.

6. The touchscreen stack of claim 3, wherein a ratio of the second linear FWHM dimension profile to the pixel pitch of a pixel is less than 2.

7. The touchscreen stack of claim 3, wherein a ratio of the second linear FWHM dimension profile to the pixel pitch of a pixel is less than 3.

8. The touchscreen stack of claim 1, wherein the diffuser is isotropic.

9. The touchscreen stack of claim 1, wherein the diffuser is anisotropic.
